(19) United States
(12) Patent Application Publication
(10) Pub. No.: US 2004/0033333 A1
(43) Pub. Date: Feb. 19, 2004

(54) Use of a napped, planar textile structure as protection against pollen for windows and doors

(76) Inventor: Andreas Schröder, Hamburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/380,412

(22) PCT Filed: Oct. 23, 2001
(86) PCT No.: PCT/EP01/12218

(30) Foreign Application Priority Data
Oct. 26, 2000 (DE) 100 53 233.0

(51) Int. Cl. B32B 3/02

(52) U.S. Cl. 428/85

(57) ABSTRACT

The use of a napped textile fabric for attachment in front of windows or doors to guard against dusty allergens such as pollen or house dust.

This invention relates to a napped textile fabric which is used as a guard against the penetration of dusty, airborne allergens such as pollen and fungal spores into living and working areas by attachment in front of windows and doors over the whole area thereof.

The incidence of pollinosis (hay fever), ie the allergic reaction of the mucous membranes of the eye and of the upper and lower respiratory tracts with flower pollen and other airborne allergens, in the population has been monitored in Germany for a number of years. It was found that about 11-15% of the population is affected. The allergic reaction of a pollen allergy usually manifests itself in reddening and lacrimation of the eyes (conjunctivitis), sneezing episodes (rhinitis) and a dry cough (bronchial asthma) as early reactions. Known late reactions to pollen allergy include for example neurodermatitis or eczema. As well as the personal symptoms of sufferers, there are more far-reaching consequences such as loss of earnings or work incapacity during the pollen season or increased medical treatment costs, so that there is an immense need for a gridlike pollen guard within the meaning of the invention for attachment in front of the windows and doors of living and working areas. Further information about pollinosis is available in Ratgeber Pollenallergie, Ute Künkele, Munich 1992.

The most important properties a pollen guard for windows and doors must offer the user are: sufficient ability to air the amenities, sufficient transparency for letting light in and for looking out, and an alleviating effect with regard to pollen allergy. The most important parameters for describing a pollen guard are accordingly: air perviousness, optical transparency and filtering effect with regard to pollen.

Guard systems attached in front of windows and doors over the whole area thereof in order that the penetration of comparatively large objects such as insects into living areas may be prevented are known (=flyscreens). DE 3045723 describes for example net curtains, nets, filters or sieves for such a purpose that are attached to window or door frames by means of press studs. Owing to their relatively large mesh sizes of 1-2 mm, these do not provide adequate protection against pollen (size about 10-50 μm) and fungal spores (size about 200 μm).

Filtration means whereby air is completely cleaned of pollen, germs and spores find use in airconditioning and automobiles. The high filtering effect is achieved in DE 3904623 for example through the use of single- or else often multi-ply filter mats formed from nonwovens which, owing to their fibrous nature, make the filter stage impassable to the abovementioned allergens. To intensify the contact of the particle-laden air with the filter, the laminate of filter mats is additionally folded in a zigzag shape. However, owing to their nonexistent visual transparency, such filter mats have no utility as a protective or guard apparatus within the meaning of the present invention. In addition, such filters for airconditioning systems in automobiles give rise to substantially higher back pressures than with the use in front of the window area by the incident air movement, so that filter fleeces have to be used. A use of filter fleeces in front of windows over the whole area thereof is not suitable as a pollen guard within the meaning of this invention because of the lack of visual transparency.

A further window guard against pollen, germs and spores is disclosed for example in DE 4300422. A textile material is attached in front of the windowpane, not over the whole area thereof, but in the two wedgelike interstices and also the rectangular opening at the upper side of a window in tilt position. This form of attachment circumvents the problem of the nonexistent visual transparency of the textile material, but to completely open the window for airing purposes the textile material has to be removed, so that there is no longer any protective effect.

It is further possible to remove pollen from air flowing into an indoor amenity by means of a woven or loop-formingly knitted fabric solely by adjusting the mesh size. The sizes of most of the allergenic pollens occurring in Europe, essentially birch, grasses, goose-foot, wormwood, plantain, hazel, are in the region of 20-40 μm. The maximum feasible mesh size for purely mechanical filtration is therefore 20 μm, and this is too small to provide visual transparency and air perviousness.

It is an object of the present invention to actualize the properties of air perviousness, visual transparency and adequate filtering effect with regard to pollen in one protective system. The pollen protective system or guard shall combine an adequate filtration efficiency of 70-80% with regard to pollen with adequate ventilation and adequate visual transparency. Good values of air perviousness for acceptable ventilation of a room are of the order of not less than 20 000 m³/m²/h given a differential pressure of 300 Pa. Adequate transparency within the meaning of the invention is a transmission between 20 and 100%. This object of adequate visual transparency and air perviousness coupled with adequate filtering performance is achieved through the use of a napped textile fabric.

Textile fabric refers to the totality of ways of producing textiles from yarn material by conventional fabric-forming operations such as drawn-loop knitting, formed-loop knitting or weaving. The fundamentals of textile fabric-forming operations can be researched in Alfons Hofer: “Stoffe 2”, 1983, Deutsch Fachbuchverlag oder “Kettwirkpraxis”, No. 4, 1970, pages 19-20, Technologien der Kettwirkerei.

Textile fabrics are napped by a napping operation following the fabric-forming operation. Napping is generally accomplished by passing the textile web over teasels, which are usually realized as rolls equipped with sharp edges, such as blades or steel brushes. In napping, individual filaments of the yarn material are severed and pulled out of the yarn, whereas the other filament end remains in the yarn. Further details can be found in Peter/Rouette: “Grundlagen der Textilveredlung”, Deutscher Fachbuchverlag Frankfurt, 1989.

Such napped fabrics are frequently used, on account of their pleasant hand, for apparel purposes for example as front appliques in the high-ticket outerwear sector, but napped fabrics are also used as a plaster material. The use of napped textile fabrics as a pollen guard in front of window areas and door openings and also for other air inlets is a new field of application and is to be protected.

The use of a napped textile fabric has the advantage over the cited approach of achieving a filtration of pollen solely by reducing the mesh size that a higher filtering effect can be achieved without process-side reduction in the mesh size, since individual severed filaments of the yarn protrude into the mesh and reduce the area of a mesh through which flow can take place. This creates spacings between the filaments that are impassible for pollen. In addition, the raising of the filaments results in the two-dimensional fabric being extended into the third dimension. The raised filaments thus on the one hand, through a longer flow path, extend the contact time of the air with the filter material and on the other enlarge the filter surface area, which leads to improved filter properties.

This permits for example a higher air perviousness which enables improved airing of the amenities, since the mesh size does not have to be reduced to the particle diameter to achieve filtering.

What is claimed is:

1. The use of a napped textile fabric for attachment in front of windows or doors to guard against dusty allergens such as pollen or house dust.
